(19) United States
(12) Patent Application Publication
(10) Pub. No.: US 2021/0323334 A1
(43) Pub. Date: Oct. 21, 2021

(54) PRINT RECEPTIVE TOPCOAT

(71) Applicant: Avery Dennison Corporation, Glendale, CA (US)

(72) Inventor: Dhananjay PATIL, Thane West (IN)

(21) Appl. No.: 17/272,441

(22) PCT Filed: Aug. 22, 2019
(86) PCT No.: PCT/US2019/047667

§ 371 Date: Mar. 1, 2021

(30) Foreign Application Priority Data
Aug. 31, 2018 (IN) 201811032688

(51) Int. Cl. B41M 5/52; B41J 3/407; B41M 5/00

(52) U.S. Cl. CPC B41M 5/5245; B41J 3/4075; B41M 5/0017; B41M 5/5281; B41M 5/5227; B41M 5/5254

(57) ABSTRACT

A topcoat comprising a cationic acrylic polymer and cationic polyurethane is provided. The cationic acrylic polymer and/or the cationic polyurethane may be crosslinked. The topcoat is a universal print receptive topcoat which has improved adhesion of a variety of printing techniques, including for low migration inks. The topcoat may be coated on a substrate, such as a label or paper. The topcoat advantageously has strong adhesion to the substrate or paper.

### PRIORITY CLAIM

This application claims priority to Indian Patent Application 201811032688 filed on Aug. 31, 2018, the entire contents and disclosures of which are incorporated herein.

### FIELD OF THE INVENTION

The present invention relates generally to a topcoat comprising a cationic acrylic polymer and a cationic polyurethane. The topcoat, may accept print from numerous individual printing platforms and may have desirable ink anchorage for both conventional and low migration inks.

### BACKGROUND OF THE INVENTION

Print receptive topcoats are used in various applications, including topcoats for films and papers. Depending on the use of the topcoat, differing printing techniques are used. Non-limiting examples of these techniques include dry toner, liquid toner, UV flexo, WB (water-based) flexo, offset, laser, and HP Indigo. Because of the compositions and methods used for these various printing techniques, the topcoat must often be tailored to maximize receptiveness of the topcoat for the specific printing technique, leading to increased manufacturing costs. Additionally, known topcoats suffer from additional problems with adhesion, antiblocking, and processing.

Various formulations of printable or print receptive topcoats, e.g., for polyolefin and/or other filmic or face materials, are generally known in the art. Although many topcoats are available, they are printable on limited platforms, have adhesion on limited films, have acceptable ink adhesion for only conventional inks, and therefore they are not considered “universal” topcoats. Additionally, many existing topcoats demand modification to achieve desired performance of processing requirements. These modifications may include external additives, cross-linkers, or other modifiers. For example, U.S. Pub. No. 2004/0197572 discloses a coated sheet in which a coating composition comprises a urethane polymer component, an acrylic polymer component, and a plurality of cross-linkers.

WO 02/38382 discloses a sheet like substrate comprising a substantially non-polar material having coated onto at least one side thereon an anchor coating to aid subsequent coating thereon of a polar coating and/or layer. The anchor coating comprises (a) a polymer comprising an optionally substituted a, 13 carboxylic acid optionally of high acid value preferably the polymer having a low T_{g}; (b) a polymer comprising an optionally unsubstituted α, β carboxylic acid optionally of low acid value preferably the polymer having a high T_{g}; and (c) a crosslinker, preferably added after a period of time to a mixture of polymers (a) and (b) to crosslink the resultant coating composition and increase the T_{g} thereof.

U.S. Pat. No. 6,866,383 discloses an ink-receptive composition, comprising: (a) a filler; (b) a binder, comprising a homopolymer, copolymer or terpolymer of a vinyl alcohol, a vinyl acetate, a vinyl chloride or combinations of two or more thereof; (c) at least one quaternary ammonium polymer and (d) at least one hydroxyalkylated polyalkyleneimine, wherein the composition, when coated on a substrate, forms an ink-receptive coating which accepts ink loading greater than about 300%.

US Pub. No. 2007/116905 discloses a thermal transfer image receiving sheet comprising: a substrate sheet supporting an image receiving resinous layer for receiving a transferred image, wherein the image receiving layer is formed by drying an aqueous coating composition. The aqueous coating composition comprises (a) at least one water dispersible aliphatic polyether-polyurethane resin, and at least one water dispersible aliphatic polyester-polyurethane resin, or (b) at least one water dispersible aliphatic polyether-polyurethane resin, a silica dispersion, and an anionic aqueous emulsion of wax; and an aqueous crosslinking agent.

U.S. Pat. No. 9,061,536 discloses a printable or print receptive topcoating for a face material, said topcoating comprising a polyether urethane; a polyurethane acrylate; a crosslinker, wherein the crosslinker comprises an amount in a range of from about 2 parts to about 15 parts based on 100 parts total solids; and an anti-blocking additive, wherein the polyurethane is a water dispersible polyurethane.

None of the above-disclosed references, however, provide for topcoats that are able to accept and retain print from various printing techniques, with various inks, while maintaining adhesiveness to the underlying substrate. In view of the foregoing drawbacks, the need exists for a cost effective topcoat that can accept and retain print from various printing techniques and inks while maintaining adhesiveness to the underlying substrate.

### SUMMARY OF THE INVENTION

In some embodiments, the disclosure is directed to a topcoat comprising: (i) a cationic acrylic polymer; and (ii) a cationic polyurethane. The cationic acrylic polymer may be present in an amount from 1 to 99 parts by weight, based on a total of 100 parts by weight. The cationic acrylic polymer may comprise an aliphatic cationic acrylate, an aromatic cationic acrylate, an aliphatic cationic methacrylate, and aromatic cationic methacrylate, or combinations thereof. In some aspects, the cationic acrylic polymer is non-crosslinkable. In other aspects, the cationic acrylic polymer is crosslinkable. The cationic polyurethane may be present in an amount from 1 to 99 parts by weight, based on a total of 100 parts by weight. In some aspects, the cationic polyurethane is non-crosslinkable. In other aspects, the cationic polyurethane is crosslinkable. When the cationic polyurethane is crosslinkable, it may be crosslinked with melamine formaldehyde, isocyanate, polyfunctional aziridine crosslinker, or multifunctional epoxy resin. The cationic acrylic polymer may have a Tg from −10° C. to 30° C. The cationic polyurethane may have a Tg from −10° C. to 30° C. In some aspects, the cationic acrylic polymer has hydroxyl functionality. In some aspects, the cationic polyurethane is an aliphatic polyether cationic polyurethane.

In some embodiments, the disclosure is directed to a coated substrate comprising a substrate and a topcoat. The topcoat may comprise: (i) a cationic acrylic polymer; and (ii) a cationic polyurethane. The cationic acrylic polymer may be present in an amount from 1 to 99 parts by weight, based on a total of 100 parts by weight. The cationic acrylic polymer may comprise an aliphatic cationic acrylate, an aromatic cationic acrylate, an aliphatic cationic methacrylate, and aromatic cationic methacrylate, or combinations thereof. In some aspects, the cationic acrylic polymer is non-crosslinkable. In other aspects, the cationic acrylic polymer is crosslinkable. The cationic polyurethane may be present in an amount from 1 to 99 parts by weight, based on a total of 100 parts by weight. In some aspects, the cationic polyurethane is non-crosslinkable. In other aspects, the cationic polyurethane is crosslinkable. When the cationic polyurethane is crosslinkable, it may be crosslinked with melamine formaldehyde, isocyanate, polyfunctional aziridine crosslinker, or multifunctional epoxy resin. The cationic acrylic polymer may have a Tg from −10° C. to 30° C. The cationic polyurethane may have a Tg from −10° C. to 30° C. In some aspects, the cationic acrylic polymer has hydroxyl functionality. In some aspects, the cationic polyurethane is an aliphatic polyether cationic polyurethane. The substrate may be a paper or a film. In some aspects, an ink is printed onto the topcoat. The ink may be a conventional ink or a low migration ink. The topcoat may be coated onto the substrate in a coat weight from 0.025 gsm to 1.0 gsm.

In some aspects, the disclosure is directed to a label comprising a substrate and a topcoat. The topcoat may comprise: (i) a cationic acrylic polymer; and (ii) a cationic polyurethane. The cationic acrylic polymer may be present in an amount from 1 to 99 parts by weight, based on a total of 100 parts by weight. The cationic acrylic polymer may comprise an aliphatic cationic acrylate, an aromatic cationic acrylate, an aliphatic cationic methacrylate, and aromatic cationic methacrylate, or combinations thereof. In some aspects, the cationic acrylic polymer is non-crosslinkable. In other aspects, the cationic acrylic polymer is crosslinkable. The cationic polyurethane may be present in an amount from 1 to 99 parts by weight, based on a total of 100 parts by weight. In some aspects, the cationic polyurethane is non-crosslinkable. In other aspects, the cationic polyurethane is crosslinkable. When the cationic polyurethane is crosslinkable, it may be crosslinked with melamine formaldehyde, isocyanate, polyfunctional aziridine crosslinker, or multifunctional epoxy resin. The cationic acrylic polymer may have a Tg from −10° C. to 30° C. The cationic polyurethane may have a Tg from −10° C. to 30° C. In some aspects, the cationic acrylic polymer has hydroxyl functionality. In some aspects, the cationic polyurethane is an aliphatic polyether cationic polyurethane. The topcoat may be coated onto the substrate in a coat weight from 0.025 gsm to 1.0 gsm. The substrate may comprise a film and a top surface of the film may be in contact with the topcoat. The film may comprise biaxially oriented polypropylene (BOPP), polyethylene terephthalate (PET), polyethylene (PE), and/or polyvinyl chloride (PVC).The substrate may further comprise an adhesive layer, wherein a top surface of the adhesive layer is in contact with a bottom surface of the film. The substrate may further comprise a release liner in contact with a bottom surface of the adhesive layer. In some aspects, the adhesive layer comprises a pressure sensitive adhesive.

In some embodiments, the disclosure is directed to a method of forming a topcoat comprising: i) combining a cationic acrylic polymer, a cationic polyurethane dispersion, and water to form a solution; (ii) coating the solution on a substrate to form a topcoat; and (iii) drying the topcoat on the substrate to form a coated substrate. The cationic acrylic polymer may be present in an amount from 1 to 99 parts by weight, based on a total of 100 parts by weight. The cationic acrylic polymer may comprise an aliphatic cationic acrylate, an aromatic cationic acrylate, an aliphatic cationic methacrylate, and aromatic cationic methacrylate, or combinations thereof. In some aspects, the cationic acrylic polymer is non-crosslinkable. In other aspects, the cationic acrylic polymer is crosslinkable. The cationic polyurethane may be present in an amount from 1 to 99 parts by weight, based on a total of 100 parts by weight. In some aspects, the cationic polyurethane is non-crosslinkable. In other aspects, the cationic polyurethane is crosslinkable. When the cationic polyurethane is crosslinkable, it may be crosslinked with melamine formaldehyde, isocyanate, polyfunctional aziridine crosslinker, or multifunctional epoxy resin. The cationic acrylic polymer may have a Tg from −10° C. to 30° C. The cationic polyurethane may have a Tg from −10° C. to 30° C. In some aspects, the cationic acrylic polymer has hydroxyl functionality. In some aspects, the cationic polyurethane is an aliphatic polyether cationic polyurethane. The substrate may be a paper or a film. In some aspects, an ink is printed onto the topcoat. The ink may be a conventional ink or a low migration ink. The topcoat may be coated onto the substrate in a coat weight from 0.025 gsm to 1.0 gsm. In some aspects, the topcoat may comprise at least one additive. The additive may include at least one of a wax, defoamer, anti-oxidant, metal oxide, UV stabilizer, filler, anti-blocking agent, or combinations thereof.

### DETAILED DESCRIPTION OF THE INVENTION

A topcoat that is able to receive and retain print from a variety of printing techniques may be useful as a universal topcoat that may be applied to various labels and papers. The topcoats described herein adhere to most of the commonly used packaging and printing films, such as polyester, biaxially oriented polypropylene, polyethylene, polypropylene, polyvinyl chloride, nylon, and the like, which retain print from various printing platforms, such as UV flexo, water based flexo, thermal transfer (TT) UV inkjet, cold foil, hot foil, letterpress, serigraphy, HP Indigo, offset, laser (cold as well as hot laser),and toner inks (including liquid and dry toner). Such inks include both conventional inks and low migration inks, as defined herein. It has now been discovered that the utilization of a cationic acrylic polymer in combination with a cationic polyurethane provides for unexpected performance properties of the resultant topcoat. The topcoat may be clear or opaque (having a white face). For example, the use of a topcoat comprising a cationic acrylic polymer and a cationic polyurethane has been found to improve ink retention on the topcoat for both conventional and low migration inks while also having sufficient adhesion of the topcoat to the film or paper to which it has been applied. The resultant topcoat may be coated onto polymer layers, such as films, or papers which are used in a variety of fields and may be referred to as a universal topcoat.

As explained herein, a problem in the art relates to inks or coatings failing to adhere to a substrate. Adhesion depends, to a great degree, on the surface energy of substrate or topcoat solution. Surface energy is related to the degree to which the surface can be wetted. Wetting indicates that the liquid, such as ink, will spread on the substrate surface. For ink to adhere to the surface, the ink must demonstrate good wetting, which occurs when the ink has a lower surface energy than the substrate. Thus, the substrate should have a greater surface energy than the print that it is intended to receive. For example, UV inks may generally have surface tensions (referred to as surface tension, because the ink is in liquid form) from 23 to 35 millinewtons per meter (mN/m). Solvent based inks, especially alcohol based inks, have a lower surface tension than UV inks. Water has a surface tension of about 72 mN/m and so water based inks generally have a greater surface tension, than UV based inks.

Although decreasing the surface tension of the print media is possible, it is more desirable to increase the surface energy of the substrate. One known method of achieving such an increase is a corona treatment, also referred to as air plasma treatment. Corona treatment, however, diminishes over time and may have to be repeated if the substrate is stored. The present inventors have surprisingly and unexpectedly discovered that the print adherence and retention may be improved by applying a topcoat comprising a cationic acrylic polymer and a cationic polyurethane to the substrate. Advantageously, the surface energy of the topcoat solution comprising the cationic acrylic polymer and cationic polyurethane does not diminish over time, while still achieving good adhesion of the topcoat to the substrate. Adhesion of the topcoat to the substrate may be tested by using 3M 810 and 3M 610 tapes. The tape is applied to the dried topcoat. The tape is left on the topcoat for 30 seconds then the tape is pulled off as fast as possible at a 180° angle to check the adhesion of the topcoat to the substrate. The substrate may then be viewed using infrared spectroscopy to check for the presence of the topcoat on the substrate. When topcoat is present on the substrate, the topcoat is said to have excellent adhesion to the substrate. Adhesion to the substrate may depend on several factors, including whether the substrate is corona treated, whether a chemical and/or mechanical bond forms between the topcoat and the substrate, whether the chemical bond is ionic, covalent, or a hydrogen bond, how the topcoat is dried, and the coat weight of the topcoat.

Additionally, adherence of low migration inks to the topcoat has been problematic in the art. Low migration inks are commonly used in food packaging applications for both direct and indirect food contact. Ink migration may occur by penetration of the ink through a substrate, by set-off transfer, or by migration via vapor phase transfer. Generally, an ink is a low migration ink if it complies with the so called “10 ppb” rule, e.g., specific migration of the ink does not exceed 10 ppb. As used herein, a conventional ink is an ink having a migration of greater than 10 ppb as measured by passing 10 g/m ink on a polyester foil under a standard mercury lamp at a speed of 20 m/minute and extracting 1 dm² of the sample with ethanol (95% vol %) for 24 hours at room temperature. As used herein, a low migration ink is an ink having a migration of less than 10 ppb, measured as described above. Migration may be caused by unreacted residual components in the ink, as well as the use of photoinitiators. In generally, low migration inks have more active defoamers than conventional inks, use a more limited choice of monomers than conventional inks, have a greater cross-linking density than convention inks, and have an absence of low molecular weight components (those under 1000 D) than conventional inks Adhesion of the ink to the topcoat may be measured using the same 3M 810 and 610 tape test described above, except that the topcoat is viewed using infrared spectroscopy to check for the presence of ink on the topcoat. If topcoat is present on the film, there are different peaks visible using infrared spectroscopy whereas if the topcoat is removed during the tape test, then only the substrate peak is visible using infrared spectroscopy.

The topcoat described herein, comprising a cationic acrylic polymer and a cationic polyurethane, has excellent adhesion to the substrate and excellent ink anchorage for both conventional and low migration inks. In some aspects, the average ink anchorage is at least 70% immediately after drying the topcoat onto the substrate, e.g., at least 80%, at least 90%, 92.5%, at least 95%, or at least 97%. In some aspects, the ink anchorage is at least 85% 24 hours after drying the topcoat onto the substrate, e.g., at least 90%, at least 92.5%, at least 95%, or at least 97%. This ink anchorage may be achieved for both convention and low migration inks. The ink may be printed onto the substrate using a flexo machine at varied speeds, e.g., speeds of 80 mpm, 100 mpm, or 150 mpm. In some aspects, the ink may be printed using cold foil, e.g., at a cold foil speed of 60 mpm or 80 mpm. Varied ink colors may be used, including white, cyan, magenta, yellow, and black, at varied lines per inch and cell volume loadings. Regardless of ink type, print speed, or printing type, the topcoats described herein had excellent ink anchorage.

### Topcoat Solution

As described herein the topcoat is formed by preparing a solution and coating that solution onto the substrate. The topcoat is a water based topcoat formed from a solution comprising a cationic acrylic polymer, a cationic polyurethane, and water. The solution may have a pH of at least 4, e.g., at least 4.5, at least 4.75, at least 5, or at least 5.25. In terms of upper limits, the solution may have a pH of less than 7, e.g., less than 6.75, less than 6.5, less than 6.25, or less than 6. In terms of ranges, the solution may have a pH from 4 to 7, e.g., from 4.5 to 6.75, from 4.75 to 6.5, from 5 to 6.25, or from 5.25 to 6. The solids content of the solution may be at least 1%, e.g., at least 2.5%, at least 5%, or at least 10%. In terms of upper limits, the solids content of the solution may be less than 45%, e.g., less than 40%, less than 37.5%, or less than 35%. In terms of ranges the solids content of the solution may range from 1 to 45%, e.g., from 2.5 to 40%, from 5 to 37.5%, or from 10 to 35%. The solution may also comprise further components as described herein, including a crosslinker. In some aspects, the solution is free of other polymers, e.g., is free of anionic polymers.

In terms of lower limits, the solution may comprise at least 20 parts by weight of a cationic acrylic polymer, based on a total of 100 parts by weight, e.g., at least 30 parts by weight or at least 50 parts by weight. In terms of upper limits, the solution may comprise less than 80 parts by weight of a cationic acrylic polymer, based on a total of 100 parts by weight, e.g., less than 75 parts by weight, or less than 70 parts by weight. In terms of ranges, the solution may comprise from 20 to 80 parts by weight of a cationic acrylic polymer, based on a total of 100 parts by weight, e.g., from 30 to 75 parts by weight, or from 50 to 70 parts by weight.

A “cationic acrylic polymer” refers to acrylic polymers that comprise cationic functional groups that impart a positive charge. The cationic acrylic polymer can be formed by any means known in that art. Suitable cationic acrylic polymers include, for example, copolymers of one or more alkyl esters of acrylic acid or methacrylic acid, optionally together with one or more other polymerizable ethylenically unsaturated monomers. Suitable alkyl esters of acrylic acid or methacrylic acid include, without limitation, methyl methacrylate, ethyl methacrylate, butyl methacrylate, ethyl acrylate, butyl acrylate, and 2-ethyl hexyl acrylate. Suitable other copolymerizable ethylenically unsaturated monomers include nitriles, such as acrylonitrile and methacrylonitrile, vinyl and vinylidene halides, such as vinyl chloride and vinylidene fluoride, and vinyl esters, such as vinyl acetate, among other monomers. Acid and anhydride functional ethylenically unsaturated monomers, such as acrylic acid, methacrylic acid or anhydride, itaconic acid, maleic acid or anhydride, or fumaric acid may be used. Amide functional monomers including, without limitation, acrylamide, methacrylamide, and N-alkyl substituted (meth)acrylamides are also suitable. Vinyl aromatic compounds, such as styrene and vinyl toluene, can also be used in certain cases.

Functional groups, such as hydroxyl and amino groups, can be incorporated into the acrylic polymer by using functional monomers, such as hydroxyalkyl acrylates and methacrylates or aminoalkyl acrylates and methacrylates. Epoxide functional groups (for conversion to cationic salt groups) may be incorporated into the acrylic polymer by using functional monomers, such as glycidyl acrylate and methacrylate, 3,4-epoxycyclohexyl methyl (meth)acrylate, 2-(3,4-epoxycyclohexyl)ethyl(meth)acrylate, or allyl glycidyl ether. Alternatively, epoxide functional groups may be incorporated into the acrylic polymer by reacting carboxyl groups on the acrylic polymer with an epihalohydrin or dihalohydrin, such as epichlorohydrin or dichlorohydrin.

In some aspects, the cationic acrylic polymer is an aliphatic cationic acrylate, an aromatic cationic acrylate, an aliphatic cationic methacrylate, an aromatic cationic methacrylate, or combinations thereof. The cationic acrylic polymer may have hydroxyl functionality or may lack hydroxyl functionality. An exemplary cationic acrylic polymer is sold as Ottopol KX 63, sold by Gellner Industries, which is a mixture of high and low molecular weight polymer chains with a weight average molecular weight from 5 to 100 kDa. The cationic acrylic polymer may have hydroxyl functionality and may have a hydroxyl value from 65 to 80, e.g., from 67.5 to 77.5, or from 70 to 75. The cationic acrylic polymer may have an acid value from 6 to 14, e.g, from 8 to 12 or from 9 to 11. The pH of the cationic acrylic polymer may be acidic, e.g., from 5 to 6.9 or from 5.5 to 6. The viscosity of the cationic acrylic polymer may range from about 500 to about 800 cps with a solids content from 38-40%.

The cationic acrylic polymer may have a glass transition temperature (Tg) of at least −10° C., e.g., at least −5° C., at least 0° C., or at least 5° C. In terms of upper limits, the cationic acrylic polymer may have a Tg of less than 30° C., e.g., less than 25° C., less than 20° C., or less than 15° C. In terms of ranges, the cationic acrylic polymer may have a Tg from −10 to 30° C., e.g., from −10 to 25° C., from −10 to 20° C., from −10 to 15° C., from −5 to 25° C., from 0 to 20° C., or from 5 to 15° C.

In terms of lower limits, the solution may comprise at least 20 parts by weight of a cationic polyurethane, based on a total of 100 parts by weight, e.g., at least 30 parts by weight or at least 50 parts by weight. In terms of upper limits, the solution may comprise less than 80 parts by weight of a cationic polyurethane, based on a total of 100 parts by weight, e.g., less than 75 parts by weight, or less than 70 parts by weight. In terms of ranges, the solution may comprise from 20 to 80 parts by weight of a cationic polyurethane, based on a total of 100 parts by weight, e.g., from 30 to 75 parts by weight, or from 50 to 70 parts by weight.

The cationic polyurethane may be an aliphatic polyurethane that is tough but flexible. In some aspects, the cationic polyurethane is co-solvent free and does not contain alkylphenol ethoxylates (APEO's). In some aspects, the cationic polyurethane may be an aliphatic polyether cationic urethane polymer, such as Alberdin GK CUD 4835 VP and Alberdingk CUD 4820, sold by Alberdingk, as well as Sancure 20051, sold by Lubrizol.

The cationic polyurethane may be in the form of a dispersion. In some aspects, the cationic polyurethane dispersion may have a solids content of at least 30%, e.g., at least 35%, or at least 40%. In terms of upper limits, the cationic polyurethane dispersion may have a solids content of less than 55%, e.g., less than 50%, or less than 45%. In terms of ranges, the cationic polyurethane dispersion has a solids content from 30 to 55%, e.g., from 35 to 50%, or from 40 to 45%. The cationic polyurethane dispersion may be acidic or neutral and may have a pH from 5 to 7, e.g., from 5.25 to 6.75, or from 5.5 to 6.5.

The cationic polyurethane may have a glass transition temperature (Tg) of at least −10° C., e.g., at least −5° C., at least 0° C., or at least 5° C. In terms of upper limits, the cationic polyurethane may have a Tg of less than 30° C., e.g., less than 25° C., less than 20° C., or less than 15° C. In terms of ranges, the cationic polyurethane may have a Tg from −10 to 30° C., e.g., from −10 to 25° C., from −10 to 20° C., from −10 to 15° C., from −5 to 25° C., from 0 to 20° C., or from 5 to 15° C.

In some aspects, the formulation comprises a crosslinker, which may crosslink the cationic polyurethane. The crosslinker may be included in an amount from 1 to 5%, based on the total solids of the cationic polyurethane, e.g., from 2 to 4% or from 2.5 to 3.5%. The crosslinker may comprise a dispersible formulation of polyfunctional aziridines, isocyanates, melamine resins, epoxies, oxazolines, carbodiimides and other multifunctional crosslinkers. In some aspects, the crosslinker may be an epoxy resin, such as a multifunctional epoxy resin. Exemplary resins include epoxidized sorbitol (for example, sold as ERISYS® 60B and ERISYS® GE-60, sorbitol polyglycidyl ether (for example, sold as DENACOL® Ex-614B). The crosslinker may also crosslink the cationic acrylic polymer. Without being bound by theory, the epoxy resin is believed to crosslink the acrylic resins in the cationic acrylic polymer to provide for improved chemical resistance in light stable coatings.

In some aspects, the solution comprises a surfactant. In terms of lower limits, the solution may comprise at least 0.001 parts by weight surfactant, based on a total of 100 parts by weight, e.g., at least 0.01 parts by weight, or at least 0.025 parts by weight. In terms of upper limits, the solution may comprise at most 3 parts by weight surfactant, based on a total of 100 parts by weight, e.g., at most 1 parts by weight or at most 0.075 parts by weight. In terms of ranges, the solution may comprise from 0.001 to 3 parts by weight surfactant, based on a total of 100 parts by weight, e.g., from 0.01 to 1 parts by weight or from 0.025 to 0.075 parts by weight.

The surfactant may be a cationic surfactant or a nonionic surfactant. Non-limiting examples of nonionic surfactants include alkylphenol ethoxylates, such as nonylphenol ethoxylate, and Disponil A 3065, an ethoxylated nonionic surfactant available from Henkel of America Inc. (King of Prussia, Pa). Examples of nonionic surfactants include TRITON X-100, TRITON X-102, TRITON X-114, TRITON X-101, and TRITON CF-10 surfactants (all available from Union Carbide Corp.); SURFYNOL CT-136 (which is actually a mixture of anionic and nonionic surfactants), SURFYNOL 104, SURFYNOL 465, and SURFYNOL TG surfactants (all available from Air Products and Chemicals of Allentown, Pa.); and Tergitol NP-9 and Tergitol NP-10 surfactants (both available from Union Carbide Chemicals and Plastics Co. of Danbury, Conn.). Surfynol 104 DPM is particularly useful because it also act to control foaming. A non-limiting example of a cationic surfactant useful in the practice of the invention is hexadecyl trimethylammonium chloride (HDTMAC), available from Akzo Nobel Chemicals Inc. (Chicago, Ill.).

In terms of lower limits, the solution may comprise at least 10 parts by weight water, based on a total of 100 parts by weight, e.g., at least 20 parts by weight or at least 30 parts by weight. In terms of upper limits, the solution may comprise less than 60 parts by weight water, based on a total of 100 parts by weight, e.g., less than 55 parts by weight, or less than 50 parts by weight. In terms of ranges, the solution may comprise from 10 to 60 parts by weight water, based on a total of 100 parts by weight, e.g., from 20 to 55 parts by weight, or from 30 to 50 parts by weight. The water may be distilled water.

In some aspects, the solution comprises a binder. In terms of lower limits, the solution may comprise at least 0.1 parts by weight of a binder, based on a total of 100 parts by weight, e.g., at least 1 part by weight or at least 3 parts by weight. In terms of upper limits, the solution may comprise less than 30 parts by weight of a binder, based on a total of 100 parts by weight, e.g., less than 20 parts by weight, or less than 10 parts by weight. In terms of ranges, the solution may comprise from 0.1 to 30 parts by weight of a binder, based on a total of 100 parts by weight, e.g., from 1 to 20 parts by weight, or from 3 to 10 parts by weight.

The binder may be included in the solution to help stabilize the solution once it is coated onto a substrate. The binder may also improve cohesion and mechanical integrity of the solution. The binder is typically are water-soluble or water-dispersible, especially when the ultimate application is aqueous-based ink jet printing, and include, for example, those selected from the group consisting of polyvinyl alcohols (PVAs); modified polyvinyl alcohols (e.g., carboxyl-modified PVA, silicone-modified PVA, maleic acid-modified PVA, and itaconic acid-modified PVA); polysaccharides; polyurethane dispersions; acrylic copolymers; vinyl acetate copolymers; poly(vinyl pyrrolidone); vinyl pyrrolidone copolymers; poly(2-ethyl-2-oxazoline); poly(ethylene oxide); poly(ethylene glycol); poly(acrylic acids); starch; modified starch (e.g., oxidized starch, cationic starch, hydroxypropyl starch, and hydroxyethyl starch), cellulosic polymers oxidized cellulose, cellulose ethers, cellulose esters, methyl cellulose, hydroxyethyl cellulose, carboxymethyl-cellulose, benzyl cellulose, phenyl cellulose, hydroxypropyl cellulose, ethyl hydroxyethyl cellulose, hydroxyethyl methyl cellulose, hydroxypropyl methyl cellulose, hydroxy butylmethyl cellulose, dihydroxypropyl cellulose, hydroxypropyl hydroxyethyl cellulose, chlorodeoxycellulose, aminodeoxycellulose, diethylammonium chloride hydroxyethyl cellulose, and hydroxypropyl trimethyl ammonium chloride hydroxyethyl cellulose); alginates and water-soluble gums; dextrans; carrageenan; xanthan; chitosan; proteins; gelatins; agar; and mixtures thereof. In some aspects, the binder is poly(vinyl pyrrolidone). In further aspects, the binder is a polyvinyl pyrrolidone/vinyl acetate copolymer (PVP/VA). The PVP/VA may have a weight ratio of vinyl pyrrolidone to vinyl acetate from 50:50 to 80:20 vinyl pyrrolidone to vinyl acetate, e.g., from 50:50 to 75:25. In some aspects, the weight ratio is 60:40 vinyl pyrrolidone to vinyl acetate. The PVP/VA may be a linear random copolymer. The PVP/VA may have a Tg of 90 to 115° C., e.g., from 95 to 110° C. or from 100 to 110° C.

In some aspects, the solution may further comprise at least one wax, such as a cationic wax. In terms of lower limits, the solution may comprise at least 0.1 parts by weight wax, based on a total of 100 parts by weight, e.g., at least 0.5 parts by weight or at least 1 part by weight. In terms of upper limits, the solution may comprise less than 15 parts by weight wax, based on a total of 100 parts by weight, e.g., less than 10 parts by weight, or less than 5 parts by weight. In terms of ranges, the solution may comprise from 0.1 to 15 parts by weight wax, based on a total of 100 parts by weight, e.g., from 0.5 to 10 parts by weight, or from 1 to 5 parts by weight.

When included, the wax helps improve scratch resistance. In one embodiment, the particles in the wax are less than 5, or less than 0.5 microns in size. The melting point of the wax or of the mixture of waxes preferably ranges from 50-150° C. In addition, the particles in the microdispersion can contain a small amount of oily or pasty fatty additives, one or more surfactants and one or more common liposoluble active ingredients. The waxes include natural (animal or plant) or synthetic substances which are solid at room temperature (20-25° C.). In one embodiment, they are insoluble in water, soluble in oils and are capable of forming a water-repellent film. A definition of waxes is provided by, for example, P. D. Dorgan, Drug and Cosmetic Industry, December 1983, pp. 30-33. The wax(es) includes carnauba wax, candelilla wax and alfalfa wax, and mixtures thereof.

In addition to these waxes, the mixture of waxes can also contain one or more of the following waxes or family of waxes: paraffin wax, ozokerite, plant waxes, such as olive wax, rice wax, hydrogenated jojoba wax or the absolute waxes of flowers, such as the essential wax of blackcurrant flower sold by the company Bertin (France), animal waxes, such as beeswaxes or modified beeswaxes (cerabellina); other waxes or waxy starting materials; marine waxes, such as those sold by the company Sophim under the identifier M82; natural or synthetic ceramides, and polyethylene or polyolefin waxes in general. The carnauba (extract of Copernica cerifera), candelilla (extract of Euphorbia cerifera and of Pedilantus pavonis) and alfalfa (extract of Stipa tenacissima) plant waxes are commercial products. Examples of commercially available waxes are Aquacer 499, 520, 537, 608 available from Byk Cera. In some aspects, the wax may be a cationic wax, such as a cationic high density polyethylene wax.

The solution may further comprise at least one additive, also referred to as an additive package. In terms of lower limits, the solution may comprise at least 0.01 parts by weight of at least one additive, based on a total of 100 parts by weight, e.g., at least 0.05 parts by weight or at least 0.1 part by weight. In terms of upper limits, the solution may comprise less than 5 parts by weight of at least one additive, based on a total of 100 parts by weight, e.g., less than 1 parts by weight, or less than 0.5 parts by weight. In terms of ranges, the solution may comprise from 0.01 to 5 parts by weight of at least one additive, based on a total of 100 parts by weight, e.g., from 0.05 to 1 part by weight, or from 0.1 to 0.5 parts by weight.

The at least one additive may be selected from the group consisting of waxes (in addition to the cationic wax disclosed herein), defoamers, anti-oxidants, UV stabilizers, fillers, anti-blocking agents and combinations thereof. In some aspects, the solution comprises at least two additives, e.g., at least three additives or at least four additives. In further aspects, the solution comprises a wax, a defoamer, and a filler as additives. In some aspects, a second wax and a filler may be included. The combination of these fillers may improve scuff and scratch resistance, as well as blocking and print receptivity, especially when a water-based print is used.

A second wax, in addition to the above described wax, may be included. The second wax may be a wax as described above, though different from the first wax. In some aspects, a non-ionic wax, such as a polyethylene terephthalate wax may be used.

When included, a defoaming agent generally reduces or mitigates the formation of foaming in the solution layer when deposited or generally handled or transferred from one location to another. Generally, any defoaming agent that does not interfere in some embodiments, desired loadings and/or physical or mechanical properties of the solution layer may be used. For instance, the defoaming agent may be mineral-based, silicone-based, or non-silicone-based.

Any suitable antioxidants for a particular embodiment may be used. In some embodiments, antioxidants may be selected that exhibit good heat resistance and mitigate the discoloration of polymeric-based articles/coatings. Exemplary antioxidants suitable for use according to certain embodiments of the present invention include, but not limited to, CHINOX 626, CHINOX 62S (organophophite antioxidant), CHINOX 245 (steric hindered phenolic antioxidant), and CHINOX 30N (blend of hindered phenolic antioxidants), each of which is commercially available from Double Bond Chemical Ind., Co., Ltd.

UV stabilizers include, but are not limited to hindered amine absorbers available from Ciba-Geigy under the trade designation Tinuvin, especially those available under the designations Tinuvin 234, Tinuvin 326, Tinuvin 327 and Tinuvin 328. The light stabilizers that can be used include the hindered amine light stabilizers available from Ciba-Geigy under the trade designations Tinuvin 111, Tinuvin 123, Tinuvin 622, Tinuvin 770 and Tinuvin 783. Also useful light stabilizers are the hindered amine light stabilizers available from Ciba-Geigy under the trade designation Chimassorb, especially Chimassorb 119 and Chimassorb 944.

Fillers include, but are not limited to metal oxides, talc, calcium carbonate, organo-clay, glass fibers, marble dust, cement dust, feldspar, silica or glass, fumed silica, silicates, alumina, various phosphorus compounds, ammonium bromide, titanium dioxide, antimony trioxide, antimony trioxide, zinc oxide, zinc borate, barium sulfate, silicones, aluminum silicate, calcium silicate, glass microspheres, chalk, mica, clays, wollastonite, ammonium octamolybdate, intumescent compounds and mixtures of two or more of these materials. The fillers may also carry or contain various surface coatings or treatments, such as silanes, fatty acids, and the like. Still other fillers can include flame retardants, such as the halogenated organic compounds. In certain embodiments, the solution layer may include one or more thermoplastic elastomers that are compatible with the other constituents of the layer, such as etherified melamine, hydroxylated polyester, polyester-melamine, and other suitable elastomers.

When includes, silica may be present in an amount from 0.10 to 20 parts by weight, based on a total weight of 100 of the topcoat, e.g., from 0.5 to 18 parts by weight, from 1 to 15 parts by weight, or from 5 to 10 parts by weight. In terms of lower limits, the topcoat comprises at least 0.10 parts by weight silica, e.g., at least 0.5 parts by weight, at least 1 part by weight, or at least 5 parts by weight. In terms of upper limits, the topcoat comprises 20 parts by weight or less of silica, e.g., less than 18 parts by weight, less than 15 parts by weight, or less than 10 parts by weight. The silica may be any type of silica, including amorphous silica, precipitated silica, fumed silica, treated silica, and/or colloidal silica.

The additive may be an anti-blocking additive. These additives reduce the tendency of the film to stick together when it is in roll form. The anti-blocking additives include natural silica, diatomaceous earth, synthetic silica, glass spheres, ceramic particles, etc. Slip additives including primary amides such as stearamide, behenamide, oleamide, erucamide, and the like; secondary amides such as stearyl erucamide, erucyl erucamide, oleyl palimitamide, stearyl stearamide, erucyl stearamide, and the like; ethylene bisamides such as N, NN-ethylenebisstearamide, N, NN-ethylenebisolamide and the like; and combinations of any two or more of the foregoing amides can also be included.

Anti-freeze additives to protect the material from freezing may be included, as well as modified non-ionic polymeric compounds, modified quaternary ammonium polymeric compounds, and cationic salts. When included, these additives may be included from 0.01 to 1 parts by weight, based on a total weight of 100, depending on requirements for performance and processing.

### Solution Preparation

The solution preparation depends on the components included. In embodiments where the solution includes a surfactant, the surfactant may first be combined with water and stirred. The binder may then be added to the water and surfactant mixture, and mixed. The binder may be added slowly under high agitation, e.g., from 500 to 1000 rpm. Mixing may occur in the presence of nitrogen purging or under vacuum to avoid microbubble formation during solution formation. The solution may then be allowed to settle, allowing for removal of any air bubbles. The solids content of the mixture may be calculated at this point. If needed, the solids content may be adjusted. Mixing may then restart. The speeds of mixing may be from 500 to 600 rpm. Next, the cationic acrylic polymer, cationic polyurethane, and any crosslinker may be added to the mixture. When included, a wax may be added and the entire mixture may be stirred. If included, additives may then be added.

The solution may then be coated onto a substrate at a coat weight described herein. The drying temperature may vary based on the substrate, but is generally at least 60° C., e.g., at least 65° C., or at least 70° C. In terms of upper limits, the drying temperature is general less than 140° C., e.g., less from 135° C. or less than 130° C. In terms of ranges, the drying temperature may range from 60 to 140° C., e.g., from 65 to 135° C. or from 70 to 130° C. In some aspects, the drying temperature for a polyethylene terephthalate substrate may range from 80 to 130° C. and the drying temperature for a polypropylene substrate and for a polyethylene substrate may range from 70 to 90° C.

### Topcoat

As described above, the solution may be coated, e.g., onto a substrate, as a topcoat. When coated as a topcoat, the water from the solution is evaporated. When included, the surfactant may also be evaporated when the topcoat is dried. Therefore, the components of the topcoat, e.g., at a minimum, the cationic acrylic polymer and the cationic polyurethane are present in different weight percentages as compared to the solution. Once coated onto a substrate, the surface energy of the topcoat may be at least 28 mN/m, e.g., at least 30 mN/m, or at least 30 mN/m. In terms of ranges, the surface energy may be from 25 to 55 mN/m, e.g., from 28 to 54 mN/m or from 30 to 50 mN/m.

In terms of lower limits, the topcoat may comprise at least 1 part by weight of a cationic acrylic polymer, based on a total of 100 parts by weight, e.g., at least 5 parts by weight, at least 10 parts by weight, at least 15 parts by weight, at least 20 parts by weight, or at least 25 70 parts by weight. In terms of upper limits, the topcoat may comprise less than 99 parts by weight of a cationic acrylic polymer, based on a total of 100 parts by weight, e.g., less than 95 parts by weight, less than 90 parts by weight, less than 85 parts by weight, less than 80 parts by weight, or less than 75 parts by weight. In terms of ranges, the topcoat may comprise from 1 to 99 parts by weight of a cationic acrylic polymer, based on a total of 100 parts by weight, e.g., from 5 to 95 parts by weight, from 10 to 90 parts by weight, from 15 to 85 parts by weight, from 20 to 80 parts by weight, or from 25 to 75 parts by weight.

In terms of lower limits, the topcoat may comprise at least 1 part by weight of a cationic polyurethane, based on a total of 100 parts by weight, e.g., at least 5 parts by weight, at least 10 parts by weight, at least 15 parts by weight, at least 20 parts by weight, or at least 25 70 parts by weight. In terms of upper limits, the topcoat may comprise less than 99 parts by weight of a cationic polyurethane, based on a total of 100 parts by weight, e.g., less than 95 parts by weight, less than 90 parts by weight, less than 85 parts by weight, less than 80 parts by weight, or less than 75 parts by weight. In terms of ranges, the topcoat may comprise from 1 to 99 parts by weight of a cationic polyurethane, based on a total of 100 parts by weight, e.g., from 5 to 95 parts by weight, from 10 to 90 parts by weight, from 15 to 85 parts by weight, from 20 to 80 parts by weight, or from 25 to 75 parts by weight.

In terms of lower limits, the topcoat may comprise at least 0.005 parts by weight surfactant, based on a total of 100 parts by weight, e.g., at least 0.02 parts by weight, or at least 0.03 parts by weight. In terms of upper limits, the topcoat may comprise at most 3 parts by weight surfactant, based on a total of 100 parts by weight, e.g., at most 1 parts by weight or at most 0.09 parts by weight. In terms of ranges, the topcoat may comprise from 0.005 to 3 parts by weight surfactant, based on a total of 100 parts by weight, e.g., from 0.02 to 1 parts by weight or from 0.03 to 0.9 parts by weight.

In some aspects, in terms of lower limits, the topcoat may comprise at least 0.1 parts by weight of a binder, based on a total of 100 parts by weight, e.g., at least 3 part by weight or at least 5 parts by weight. In terms of upper limits, the topcoat may comprise less than 40 parts by weight of a binder, based on a total of 100 parts by weight, e.g., less than 30 parts by weight, or less than 15 parts by weight. In terms of ranges, the topcoat may comprise from 0.1 to 40 parts by weight of a binder, based on a total of 100 parts by weight, e.g., from 3 to 30 parts by weight, or from 5 to 15 parts by weight.

In some aspects, the topcoat may further comprise at least one wax, such as a cationic wax. In terms of lower limits, the topcoat may comprise at least 0.1 parts by weight wax, based on a total of 100 parts by weight, e.g., at least 2 parts by weight or at least 3 parts by weight. In terms of upper limits, the topcoat may comprise less than 20 parts by weight wax, based on a total of 100 parts by weight, e.g., less than 15 parts by weight, or less than 10 parts by weight. In terms of ranges, the topcoat may comprise from 0.1 to 20 parts by weight wax, based on a total of 100 parts by weight, e.g., from 2 to 15 parts by weight, or from 3 to 10 parts by weight.

In some aspects, the topcoat may further comprise at least one additive. In terms of lower limits, the topcoat may comprise at least 0.01 parts by weight of at least one additive, based on a total of 100 parts by weight, e.g., at least 0.1 parts by weight or at least 0.3 parts by weight. In terms of upper limits, the topcoat may comprise less than 10 parts by weight of at least one additive, based on a total of 100 parts by weight, e.g., less than 5 parts by weight, or less than 1 part by weight. In terms of ranges, the topcoat may comprise from 0.01 to 10 parts by weight of at least one additive, based on a total of 100 parts by weight, e.g., from 0.1 to 5 parts by weight, or from 0.3 to 1 parts by weight.

The coat weight of the topcoat may vary, but is generally within the range from 0.1 to 1.5 grams per square meter (“gsm”), e.g., from 0.1 to 1.25 gsm or from 0.25 to 1 gsm. The substrate is generally a film (such as a polymer described herein), a label, paper, or a metal foil.

In some aspects, the topcoat is coated onto a label, which generally comprises a facestock layer. The facestock layer may be a polymer layer as described herein, such as a polyvinyl chloride or polyolefin film that is directly adjacent to the topcoat. The polyolefin film has top and bottom surfaces. From the perspective looking downwardly toward the substrate, the polyolefin film may be configured beneath the topcoat, e.g., the top surface of the polyolefin film is adjacent the topcoat. In some aspects, the polymer film is polyethylene, polypropylene (including biaxially oriented polypropylene (BOPP)), or polyethylene terephthalate.

The polyolefin film may vary widely. In some embodiments, the polyolefin film may comprise any polyolefin material that exhibits good mechanical strength and heat resistance. Exemplary polyolefin films may comprise at least one of a polyimide, a polyester, a polyetherimide (PEI), a polyethylene naphthalate (PEN), a polyether sulfone (PES), a polysulfone, polymethylpentene (PMP), a polyvinylidene fluoride (PVDF), an ethylene-chlorotrifluoroethylene (ECTFE), or combinations thereof. In certain embodiments, especially when the label may be used at high temperatures, the polyolefin film comprises at least one polyimide.

Exemplary polyolefin films made of polyimide include Kapton®, available from DuPont, and Apical©, available from Kaneka Texas Corporation, Exemplary polyolefin films made of polyester include Mylar©, available from DuPont, and 2600 polyethylene terephthalate film, available from American Hoechst. Other commercially available polyolefin films include Tempalux™ (PEI), available from Westlake Plastics Company; Superio-UT™ (PEI), available from Mitsubishi Plastics, Kaladex™; (PEN) and Teonex (PEN), both available from DuPont.

The polyolefin films according to certain embodiments of the present invention may comprise a thickness ranging from 1 to 400 microns, e.g., from 10 to 300 microns, from 25 to 200 microns, or from 50 to 150 microns, and other ranges in the foregoing amounts. In terms of lower limits, the polyolefin films may have a thickness of at least 1 micron, e.g., at least 10 microns, at least 25, or at least 50 microns and may exceed 300 microns. In terms of upper limits, the polyolefin films may have a thickness less than 400 microns, e.g., less than 300 microns, less than 200 microns, or less than 150 microns.

In some aspects, the label may further comprise a primer layer. The primer layer may be directly adjacent to the polyolefin film on the opposite surface of the polyolefin film from the topcoat, e.g., the polyolefin film may be configured between the topcoat and the primer layer. The primer layer may comprise a crosslinker and optionally may include additives as disclosed for the topcoat. The primer layer may be coated onto the polyolefin film by gravure. After curing at a temperature from about 150 to 180° C., the primer is affixed to the film. Additionally, when crosslinker is included in the primer layer, the hydroxyl group on the polyolefin film with react with the crosslinker and thus the primer layer is chemically bonded to the polyolefin film.

The thickness of the primer layer may range from 0.01 to 50 microns, e.g., from 0.1 to 25 microns, or from 0.5 to 10 microns. In terms of lower limits, the primer layer may have a thickness of at least 0.01 micron, e.g., at least 0.1 microns, or at least 0.5 micros. In terms of upper limits, the primer layer may have a thickness less than 50 microns, e.g., less than 25 microns, or less than 10 microns.

The label may further comprise an adhesive layer. The adhesive layer may comprise any adhesive that is effective in binding the label to an external surface of the substrate to which the label may be affixed. In some aspects, the adhesive may be a pressure sensitive adhesive. An aggressive pressure sensitive adhesive may be used, such as one of the high-strength or rubber-modified acrylic pressure sensitive adhesives, such as Duro-Tak® 80-115 A available from National Starch and Chemical Co. or Aroset™ 1860-Z-45 available from Ashland Specialty Chemical Company. Suitable pressure sensitive adhesives may include, for example, copolymers of alkyl acrylates that have a straight chain of from 4 to 12 carbon atoms and a minor proportion of a highly polar copolymerizable monomer such as acrylic acid. These adhesives are more fully described in U.S. Pat. Re. 24,906 and U.S. Pat. No. 2,973,286, the contents of each are hereby incorporated by reference in their entirety. Alternative pressure sensitive adhesives include ultraviolet curable pressure sensitive adhesives, such as Duro-Tak 4000, which is available from National Starch and Chemical Co.

The label may further comprise a releasable liner. The releasable liner may be positioned directly adjacent to the adhesive layer, on the opposite side of the adhesive layer from the primer layer. In this regard, the releasable liner may protect the adhesive layer before the label is applied (or intended to be applied) to an object or facestock, such as during manufacture, printing, shipping, storage, and at other times. Any suitable material for a releasable liner may be used. Typical and commercially available releasable liners, which can be suitable for embodiments of the present invention, can include a silicone-treated release paper or film, such as those available from Loparex, including products such as 1011, 22533 and 1 1404, CP Films, and Akrosil™.

Each of the layers of the label may also contain additives in amounts as described herein, including antioxidants and cross-linkers.

In further embodiments, the solution may be coated onto paper, such as cast gloss paper. The topcoat disclosed herein beneficially exhibits good adhesion to cast gloss paper. The coat weight of the topcoat may vary, but is generally within the range from 0.1 to 1.5 grams per square meter (“gsm”), e.g., from 0.1 to 1.25 gsm or from 0.2 to 1 gsm. The coat weight of the topcoat may be adjusted if a specific range for the coat weight or solids content is desired. Generally, a greater coat weight and solids content are desired for a topcoat coated onto paper as compared to a topcoat coated onto a polyolefin film.

In some aspects, an ink is printed onto the topcoat. Suitable inks include conventional and low migration inks as described herein. The ink may be a UV or water based-ink, though other types of inks are also contemplated. Exemplary low migration inks include Siegwerk-Nutriflex, Flint-Ancora, C Zeller Y81, D Siegwerk Sicura 98-8, E Fliny Flexocure Force, and Zeller Y80.

The following embodiments are contemplated. All combinations of features and embodiments are contemplated.

### Embodiment 1

A topcoat comprising: (i) a cationic acrylic polymer; and (ii) a cationic polyurethane.

### Embodiment 2

An embodiment of embodiment 1, wherein the cationic acrylic polymer is present in an amount from 1 to 99 parts by weight, based on a total of 100 parts by weight.

### Embodiment 3

An embodiment of any one of the embodiments of embodiments 1-2, wherein the cationic acrylic polymer is selected from the group consisting of an aliphatic cationic acrylate, an aromatic cationic acrylate, an aliphatic cationic methacrylate, and aromatic cationic methacrylate, and combinations thereof.

### Embodiment 4

An embodiment of any one of the embodiments of embodiments 1-3, wherein the cationic acrylic polymer is non-crosslinkable.

### Embodiment 5

An embodiment of any one of the embodiments of embodiments 1-3, wherein the cationic acrylic polymer is crosslinkable.

### Embodiment 6

An embodiment of any one of the embodiments of embodiments 1-5, wherein the cationic polyurethane is present in an amount from 1 to 99 parts by weight, based on a total of 100 parts by weight.

### Embodiment 7

An embodiment of any one of the embodiments of embodiments 1-6, wherein the cationic polyurethane is non-crosslinkable.

### Embodiment 8

An embodiment of any one of the embodiments of embodiments 1-6, wherein the cationic polyurethane is crosslinkable.

### Embodiment 9

An embodiment of embodiments 8, wherein the cationic polyurethane is crosslinked with melamine formaldehyde, isocyanate, polyfunctional aziridine crosslinker, or multifunctional epoxy resin.

### Embodiment 10

An embodiment of any one of the embodiments of embodiments 1-9, wherein the cationic acrylic polymer has a Tg from −10° C. to 30° C.

### Embodiment 11

An embodiment of any one of the embodiments of embodiments 1-10, wherein the cationic polyurethane has a Tg from −10° C. to 30° C.

### Embodiment 12

An embodiment of any one of the embodiments of embodiments 1-11, wherein the cationic acrylic polymer has hydroxyl functionality.

### Embodiment 13

An embodiment of any one of the embodiments of embodiments 1-12, wherein the cationic polyurethane is an aliphatic polyether cationic polyurethane.

### Embodiment 14

A coated substrate comprising: (a) a substrate and (b) a topcoat according to any of embodiments 1-13.

### Embodiment 15

An embodiment of embodiment 14, wherein the substrate is a paper or a film.

### Embodiment 16

An embodiment of any one of embodiments 14-15, further comprising an ink printed onto the topcoat.

### Embodiment 17

An embodiment of embodiment 16, wherein the ink is a low migration ink.

### Embodiment 18

An embodiment of any one of embodiments 14-17, wherein the topcoat is coated onto the substrate in a coat weight from 0.025 gsm to 1.0 gsm.

### Embodiment 19

A label comprising: (a) a substrate; and (b) a topcoat according to any embodiments 1-13 in contact with the substrate.

### Embodiment 20

An embodiment of embodiment 19, wherein the topcoat is coated onto the label in a coat weight from 0.025 to 1.0 gsm.

### Embodiment 21

An embodiment of any one of the embodiments of embodiments 19-20, wherein the substrate comprises a film and wherein a top surface of the film is in contact with the topcoat.

### Embodiment 22

An embodiment of embodiment 21, wherein the film comprises bioaxially oriented polypropylene (BOPP), polyethylene terephthalate (PET), polyethylene (PE), and/or polyvinyl chloride (PVC).

### Embodiment 23

An embodiment of any one of the embodiments of embodiments 21-22, wherein the substrate further comprises an adhesive layer, wherein a top surface of the adhesive layer is in contact with a bottom surface of the film.

### Embodiment 24

An embodiment of embodiment 23, wherein the substrate further comprises a release liner in contact with a bottom surface of the adhesive layer.

### Embodiment 25

An embodiment of embodiment 24, wherein the adhesive layer comprises a pressure sensitive adhesive.

### Embodiment 26

A method of forming a topcoat comprising: i) combining a cationic acrylic polymer, a cationic polyurethane dispersion, and water to form a solution; (ii) coating the solution on a substrate to form a topcoat; and (iii) drying the topcoat on the substrate to form a coated substrate.

### Embodiment 27

An embodiment of embodiment 26, wherein the cationic acrylic polymer is present in an amount from 1 to 99 parts by weight, based on a total of 100 parts by weight of the topcoat.

### Embodiment 28

An embodiment of any one of the embodiments of embodiments 26-27, wherein the cationic acrylic polymer comprises an aliphatic cationic acrylate, an aromatic cationic acrylate, an aliphatic cationic methacrylate, an aromatic cationic methacrylate, or combinations thereof.

### Embodiment 29

An embodiment of any one of the embodiments of embodiments 26-28, wherein the cationic acrylic polymer is non-crosslinkable.

### Embodiment 30

An embodiment of any one of the embodiments of embodiments 26-29, wherein the cationic acrylic polymer is crosslinkable.

### Embodiment 31

An embodiment of any one of the embodiments of embodiments 26-29, wherein the cationic polyurethane dispersion is present in an amount from 1 to 99 parts by weight, based on a total of 100 parts by weight of the topcoat.

### Embodiment 32

An embodiment of any one of the embodiments of embodiments 26-31, wherein the solution comprises a crosslinker.

### Embodiment 33

An embodiment of any one of the embodiments of embodiments 26-32, wherein the topcoat further comprises at least one additive.

### Embodiment 34

An embodiment of embodiment 33, wherein the additive is at least one of a wax, defoamer, anti-oxidant, metal oxide, UV stabilizer, filler, anti-blocking agent, or combinations thereof.

While the invention has been described in detail, modifications within the spirit and scope of the invention will be readily apparent to those of skill in the art. It should be understood that aspects of the invention and portions of various embodiments and various features recited herein and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

1. A topcoat comprising: (i) a cationic acrylic polymer; and (ii) a cationic polyurethane.

2. The topcoat of claim 1, wherein the cationic acrylic polymer is present in an amount from 1 to 99 parts by weight, based on a total of 100 parts by weight.

3. The topcoat of claim 1, wherein the cationic acrylic polymer is selected from the group consisting of an aliphatic cationic acrylate, an aromatic cationic acrylate, an aliphatic cationic methacrylate, and aromatic cationic methacrylate, and combinations thereof.

4. The topcoat of claim 1, wherein the cationic acrylic polymer is non-crosslinkable.

5. The topcoat of claim 1, wherein the cationic acrylic polymer is crosslinkable.

6. The topcoat of claim 1, wherein the cationic polyurethane is present in an amount from 1 to 99 parts by weight, based on a total of 100 parts by weight.

7. The topcoat of claim 1, wherein the cationic polyurethane is non-crosslinkable.

8. The topcoat of claim 1, wherein the cationic polyurethane is crosslinkable.

9. The topcoat of claim 8, wherein the cationic polyurethane is crosslinked with melamine formaldehyde, isocyanate, polyfunctional aziridine crosslinker, or multifunctional epoxy resin.

10. The topcoat of a claim 1, wherein the cationic acrylic polymer has a Tg from −10° C. to 30° C.

11. The topcoat of claim 1, wherein the cationic polyurethane has a Tg from −10° C. to 30° C.

12. The topcoat of claim 1, wherein the cationic acrylic polymer has hydroxyl functionality.

13. The topcoat of claim 1, wherein the cationic polyurethane is an aliphatic polyether cationic polyurethane.

14. A coated substrate comprising: (a) a substrate and (b) a topcoat according to claim 1.

15. The coated substrate of claim 14, wherein the substrate is a paper or a film.

16. The coated substrate of claim 14, further comprising an ink printed onto the topcoat, preferably a low migration ink.

17. The coated substrate of claim 14, wherein the topcoat is coated onto the substrate in a coat weight from 0.025 gsm to 1.0 gsm.

18. A label comprising: (a) a substrate; and (b) a topcoat according to claim 1 in contact with the substrate.

19. The label of claim 18, wherein the topcoat is coated onto the label in a coat weight from 0.025 to 1.0 gsm.

20. The label of claim 18, wherein the substrate comprises a film and wherein a top surface of the film is in contact with the topcoat.

21. The label of claim 20, wherein the film comprises bioaxially oriented polypropylene (BOPP), polyethylene terephthalate (PET), polyethylene (PE), and/or polyvinyl chloride (PVC).

22. The label of claim 20, wherein the substrate further comprises an adhesive layer, wherein a top surface of the adhesive layer is in contact with a bottom surface of the film.

23. The label of claim 22, wherein the substrate further comprises a release liner in contact with a bottom surface of the adhesive layer.

24. The label of claim 23, wherein the adhesive layer comprises a pressure sensitive adhesive.

25. A method of forming the topcoat of claim 1, comprising: i) combining the cationic acrylic polymer, a cationic polyurethane dispersion, and water to form a solution; (ii) coating the solution on a substrate to form a topcoat; and (iii) drying the topcoat on the substrate to form a coated substrate.

26. The method of claim 25, wherein the topcoat further comprises at least one additive, preferably wherein the additive is at least one of a wax, defoamer, anti-oxidant, metal oxide, UV stabilizer, filler, anti-blocking agent, or combinations thereof.
